(19) United States
(12) Patent Application Publication
(10) Pub. No.: US 2024/0100744 A1
(43) Pub. Date: Mar. 28, 2024

(54) Rubber Tire Repurposing System and Method of Use

(71) Applicant: Joseph Leon, Bakersfield, CA (US)

(72) Inventor: Joseph Leon, Bakersfield, CA (US)

(21) Appl. No.: 18/470,577

(22) Filed: Sep. 20, 2023

Related U.S. Application Data
(60) Provisional application No. 63/409,015, filed on Sep. 22, 2022.

(51) Int. Cl. B29B 17/02; B29B 17/04

(52) U.S. Cl. CPC B29B 17/02; B29B 17/04; B29B 2017/0015; B29B 2017/0227

(57) ABSTRACT

A system and method for recycling and repurposing used tires. The system includes a plurality of modules for automatically repurposing used tires into fabrication of structural members or devices including but not limited to tie-downs, attachment cables, speed bumps, tire chocks, pet scratching posts, fencing, safety barriers, and more. The treads of the tires are used for making elongated strips which are joined using adhesive(s) for forming structures. In some embodiments, the temperature and pressure for the repurposing process can be adjusted using an interface. The used tires are cleaned and waste material is removed after treads are separated.

### CROSS-REFERENCE TO RELATED APPLICATION

The present application claims priority to, and the benefit of, U.S. Provisional Application No. 63/409,015, which was filed on Sep. 22, 2022 and is incorporated herein by reference in its entirety.

### FIELD OF THE INVENTION

The present invention generally relates to the field of recycling and repurposing of used tires. More specifically, the present invention relates to a novel system and method for repurposing used tire treads to be used for a variety of purposes, including fencing, tie-downs, attachment cables, speed bumps, tire chocks, and more. The system includes a plurality of modules for forming strips and joining strips using adhesive, industrial staples, and/or tubular metal braids for forming preconfigured repurposed objects. Accordingly, the present disclosure makes specific reference thereto. Nonetheless, it is to be appreciated that aspects of the present invention are also equally applicable to other like applications, devices, and methods of manufacture.

### BACKGROUND

By way of background, millions of tires are discarded each year and with growing population and expanding economies around the world, the number of discarded tires is expected to continue growing. In fact, used tires are a significant source of environmental waste and pollution. As millions of tires are discarded each year, they take up space in landfills and junkyards and pose a significant threat to the environment. The discarded tires are not biodegradable, and they release harmful chemicals and pollutants into the environment, including carbon monoxide, nitrogen oxide, and sulfur dioxide, which contribute to air pollution.

In addition to air pollution, discarded tires also pose a threat to water sources. Rainwater can accumulate in tire piles, creating stagnant pools that provide breeding grounds for mosquitoes and other disease-carrying insects. As the tires break down, they can release toxic chemicals into the groundwater, contaminating drinking water supplies and causing further harm to the environment.

Authorities and tire manufacturers have invested significant amounts of money into researching and developing new technologies for recycling rubber. However, a sustainable, cost-effective, and efficient method of disposing and repurposing used tire treads is not currently available and is therefore, desired by individuals.

Therefore, there exists a long felt need in the art for a used tire tread repurposing method for safely disposing and reusing used tire treads. There is also a long felt need in the art for a system and method that utilizes waste tire parts to form useful structural members. Additionally, there is a long felt need in the art for a used tire repurposing method that reduces waste and offers an environmentally-friendly alternative to conventional discarding of used tires. Moreover, there is a long felt need in the art for repurposing used tires that prevent pollution caused by the used tires. Further, there is a long felt need in the art for a method that prevents filling up landfills and junkyards with discarded tires. Finally, there is a long felt need in the art for a method of recycling used tire treads to create different, usable structures/items that can significantly reduce waste and help the environment.

The subject matter disclosed and claimed herein, in one embodiment thereof, comprises a tire recycling and repurposing system for processing different types and sizes of used tires into different repurposed products such as tie-downs, attachment cables, speed bumps, tire chocks, pet scratching posts, safety barriers, and more. The system is installed at a facility and features a plurality of modules including a tire feeder module for receiving used tires, a tire separator module for separating different types of tires and treads, a strips formation module for cutting treads into a plurality of elongated strips, a strip binder module for binding two or more strips together using a new or waste thermoplastics or rubber adhesive, industrial staples, and/or tubular metal braids, and a structural member casting module for repurposing the bonded strips into various products.

In this manner, the tire recycling and repurposing system and associated method of the present invention accomplish all of the forgoing objectives and provide users with a means of repurposing used tire treads for a variety of purposes. The system reduces waste and offers an environmentally friendly alternative to discarding used tires.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tire recycling and repurposing system for processing different types and sizes of used tires into different repurposed products. The system further comprises a tire feeder module for receiving used tires, a tire separator module for separating different types of tires and treads, a strip formation module for cutting treads into a plurality of elongated strips, a strip binder module for binding two or more strips together using a new or waste thermoplastics or rubber adhesive, industrial staples, and/or tubular metal braids, and a structural member casting module for repurposing the bonded strips into various products. The system is automated and handles high volumes of used tires, and the resulting repurposed products can be used in a wide variety of applications, such as construction, transportation, pet products, and more.

In yet another embodiment, the system includes a computer system configured to provide a user interface, wherein the user interface enables choices for an adhesive type option and a set agitator speed option, enabling a user to select a specific type of adhesive and to set a desired agitator speed for effectively separating the tires and treads, respectively.

In yet another embodiment, the user interface includes a set temperature and pressure option, enabling a user to maintain a desired temperature and pressure inside the strips formation module for efficient strips formation without any waste or environmental hazard.

In yet another embodiment, a method for repurposing used tires is described. The method comprising the steps of cleaning the used tires to remove dirt and debris, separating the treads from the tires, forming elongated strips of different lengths, widths, and thickness from the treads, joining two or more strips using an adhesive, industrial staples, and/or tubular metal braids in a preconfigured configuration, and using the joined strips to form one or more structures that are anti-slipping, durable, weatherproof, and environmentally friendly.

In yet another embodiment, the components of the repurposing system of the present invention are easily and efficiently manufactured, marketed and available to consumers in cost-effective manner and are easily used by users for recycling and repurposing tires while reducing waste and offers an environmentally friendly alternative to discarding used tires.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of an exemplary embodiment of the tire repurposing system of the present invention in accordance with the disclosed architecture;

FIG. 2 illustrates an exemplary user interface offered by the tire repurposing system of the present invention for configuring the system for specific usage in accordance with the disclosed architecture;

FIG. 3 illustrates a perspective view showing two strips made of treads bounded together using rubber adhesive with each strip used with a tube in accordance with the disclosed architecture;

FIG. 4 illustrates a perspective view of a tire chock made of the tread strips using the tires recycling and repurposing system of the present invention in accordance with the disclosed architecture;

FIG. 5 illustrates a perspective view showing the tire chock used with a vehicle in accordance with the disclosed architecture;

FIG. 6 illustrates a flow diagram depicting a process for repurposing rubber tires for use in a wide variety of applications using the system of the present invention in accordance with the disclosed architecture;

FIG. 7 illustrates a perspective view showing two strips made of treads bounded together using industrial staples in accordance with the disclosed architecture; and

FIG. 8 illustrates a perspective view showing two strips made of treads bounded together using a tubular metal braid in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a used tire treads repurposing method for safely disposing and reusing the used tire treads. There is also a long felt need in the art for a system and method that utilize waste tire parts to form useful structural members. Additionally, there is a long felt need in the art for a used tire repurposing method that reduces waste and offers an environmentally friendly alternative to conventional discarding of used tires. Moreover, there is a long felt need in the art for repurposing used tires that prevent pollution caused by the used tires. Further, there is a long felt need in the art for a method that prevents filling up landfills and junkyards with discarded tires. Finally, there is a long felt need in the art for a method of recycling used tires treads to create different, usable structures/items could significantly reduce waste and help the environment.

The present invention, in one exemplary embodiment, is a method for repurposing used tires. The method comprising the steps of cleaning the used tires to remove dirt and debris, separating the treads from the tires, forming elongated strips of different lengths, widths, and thickness from the treads, joining two or more strips using an adhesive, industrial staples, and/or tubular metal braids in a preconfigured configuration, and using the joined strips to form one or more structures that are anti-slipping, durable, weatherproof, and environmentally friendly. It is to be appreciated that a tubular metal braid includes an expandable, flexible, and high strength metal braid joiner used for securing one strip to another strip.

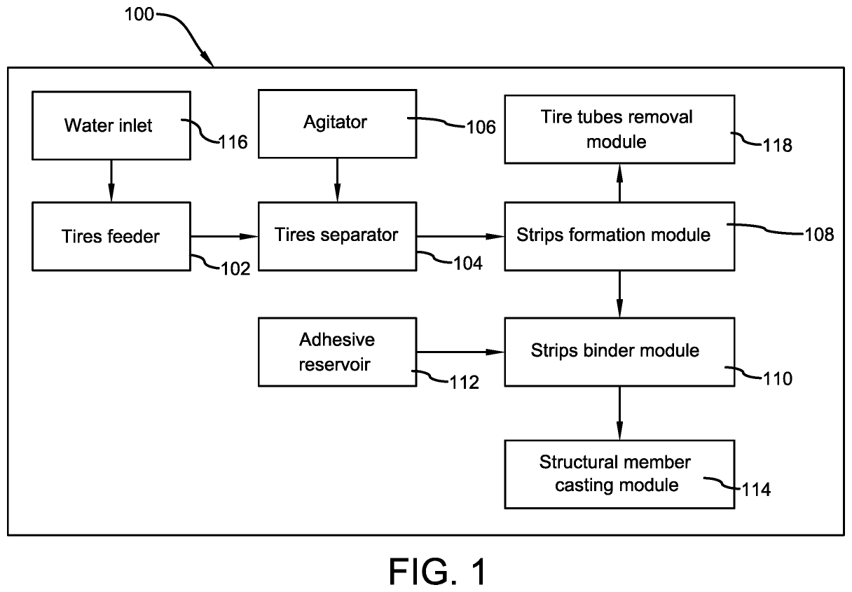

Referring initially to the drawings, FIG. 1 illustrates a schematic diagram of an exemplary embodiment of the tire repurposing system of the present invention in accordance with the disclosed architecture. The tire repurposing system 100 of the present invention is operated in a facility and can be used by authorities, tires manufacturers and more for repurposing rubber tires for use in a wide variety of applications. More specifically, the system 100 is a modular system having a plurality of components or modules for performing different tasks enabling repurposing of used tires. A tire feeder module 102 is configured for receiving different types of used tires of different sizes and configurations. The feeder module 102 feeds the received used tires into the system 100 for further processing. The feeder 102 is designed to accommodate different types and sizes of tires. In a preferred embodiment, the feeder module 102 includes a conveyer belt for carrying the used tires for repurposing. It should be noted that the tires input into the system 100 are free from dirt, debris and are cleaned in the tire feeder module 102 using a water inlet 116 which sprays a cleaning solution on the used tires.

A tire separator module 104 is connected to the feeder module 102 and is configured for separating different types of tires and also separating the treads such as steel-reinforced tire treads from the rest of the tire. The tire separator module 104 can handle high volumes of tires and efficiently separate different types of tires and the treads from the tires. The tire separator module 104 is connected to an agitator 106 for providing the vibration and rotation to separate different types of tires. The agitator 106 can have an integrated motor for producing vibration and rotation in the tire separator module 104.

The strips formation module 108 is configured for cutting the individual tire treads into long strips. The module 108 has a plurality of elongated cutters disposed therein for uniformly cutting the treads into long strips. The module 108 is able to handle different sizes of treads of different types of tires and cut the treads into consistent and uniform strips. During strips formation, any tire tubes or other remaining material from the module 108 is transferred to the tire tubes removal module 118. The tire tubes in one embodiment can be used as a cable that can be used to tie down buoys.

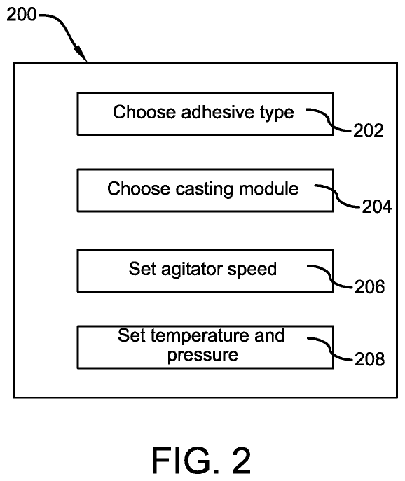

The plurality of strips formed in the module 108 are transferred to a strip binder module 110 which captures, encapsulates, or binds two or more tire tread strips together using new or waste thermoplastics, such as polyethylene and/or polypropylene, or a rubber adhesive. The module 110 can be configured for binding tread strips in different angles and orientations using a user interface 202 illustrated in FIG. 2. It should be appreciated that the system 100 is automatic and can work on a set of parameters defined by a user using the user interface 202. The adhesive used for binding or encapsulating the strips is stored in an adhesive reservoir 112 which is coupled to the strip binder module 110. The reservoir 112 can hold up to 1500 liters of one or more adhesive material for providing a sufficient amount of material to ensure continuous operation of the system 100.

For repurposing the bonded strips, a structural member casting module 114 is used. The casting module 114 includes a plurality of different casting structures configured to repurpose the treads into a plurality of items including and not limited to tie-downs, attachment cables, speed bumps, tire chocks, pet scratching posts, safety barriers, and more.

FIG. 2 illustrates an exemplary user interface offered by the tire repurposing system of the present invention for configuring the system for specific usage in accordance with the disclosed architecture. As illustrated, the user interface 200 offers an adhesive type option 202 configured to enable a user to choose a specific type of adhesive from the reservoir 112. The reservoir 112 can hold two or more types of adhesives in different and independent tanks disposed therein and either one of the stored adhesives can be selected and used for binding the strips. The selection can be done on the type of tires and length of the strips required. As the system 100 can be used for forming different types of structures from the tire treads, therefore, for a specific type of structural item, one of the casting modules can be chosen using the casting module option 204.

For effectively separating tires and treads from the tires, a specific agitator speed can be selected for the agitator to provide desired rotation and vibration using set agitator speed option 206. The agitator speed can be between 100 rpm and 2500 rpm based on volume of the tires. For effective strips formation without any waste and environment hazard, a desired temperature and pressure is maintained inside the strips formation module 108 using the set temperature and pressure option 208. The temperature of the reservoir 112 is also maintained for keeping the adhesives in a molten state enabling easy application on the strips for binding the strips.

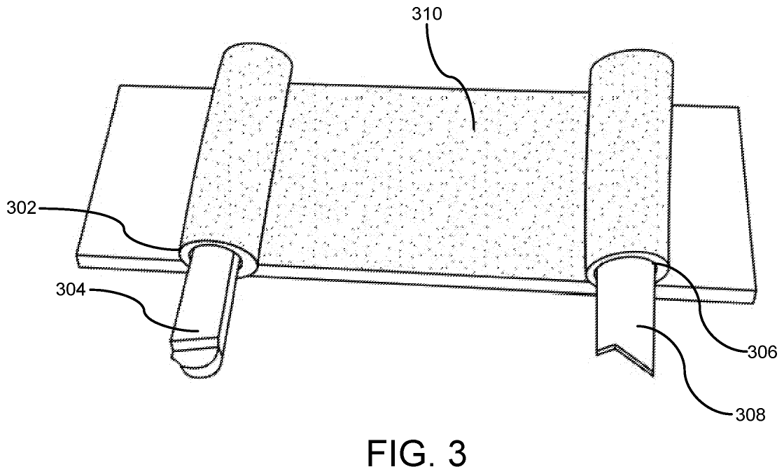

FIG. 3 illustrates a perspective view showing two strips made of treads bounded together using rubber adhesive with each strip used with a tube in accordance with the disclosed architecture. As illustrated, the first tube 302 is used with a first strip 304 and the second tube 306 is used with a second strip 308. The tubes 302, 306 can be tire tubes which can be raw or vinyl coated, and further can be made from the tire tubes removal module 118 of the system 100. The strips 304, 308 are bounded to respective tubes 302, 306 using adhesive or polyethylene. Further, to make a desired structure, the tubes 302, 306 are bounded using the same adhesive 310. The strips 304, 308 can be attached in any desired orientation with the respective tubes 302, 306.

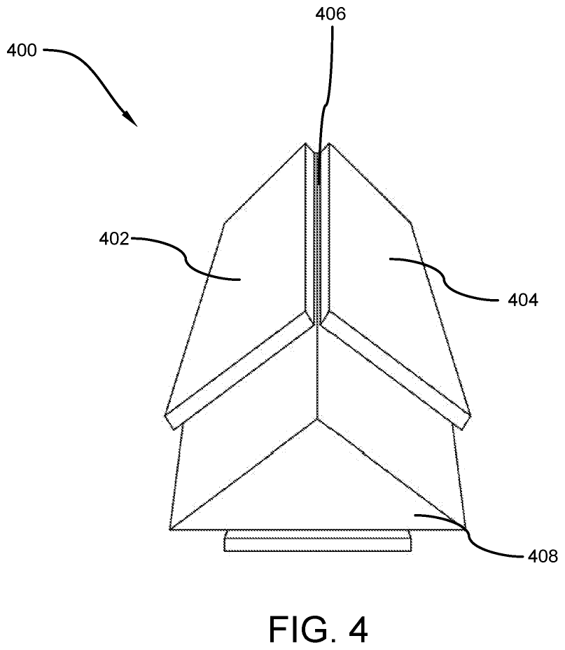

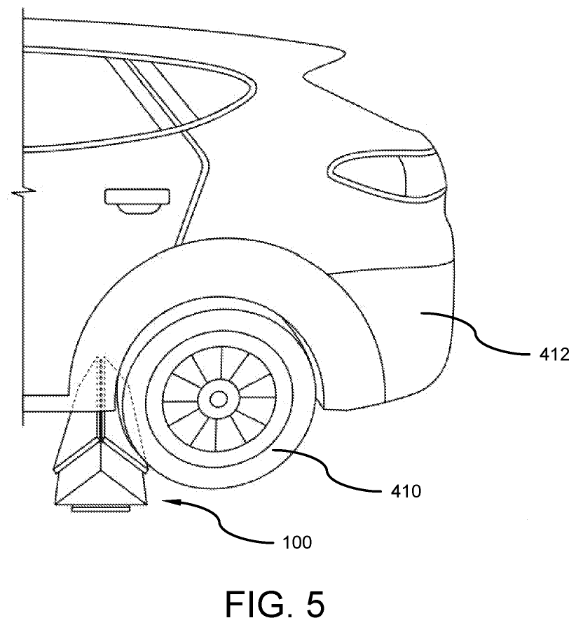

FIG. 4 illustrates a perspective view of a tire chock made of the tread strips using the tires recycling and repurposing system of the present invention in accordance with the disclosed architecture. As described earlier in the disclosure, the system 100 can be used for making multiple types of structural elements and in the present embodiment, the tire chock 400 is made of two strips 402, 404 attached angularly along a common edge 406. The tire chock 400 uses a durable polymer or other type of material 408 on which the strips 402, 404 are fastened. The tire chock 400 functions as any conventional tire chock for a tire 410 of a vehicle 412 as illustrated in FIG. 5.

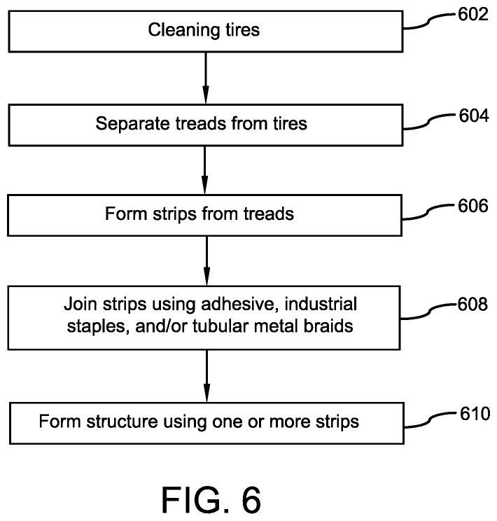

FIG. 6 illustrates a flow diagram depicting a process for repurposing rubber tires for use in a wide variety of applications using the system 100 of the present invention in accordance with the disclosed architecture. Initially, the used tires are cleaned using water and any other cleaning solution for removing any dirt, debris, and more (Step 602). The used tires can be of different sizes and types. Then, treads and tubes are separated from the tires and other waste materials are also removed (Step 604). Any type of automated cutting tool such as a cutter can be used for removing treads and tubes. Thereafter, elongated strips of different lengths, widths, and thickness are formed from treads (Step 606). The strips are preferably made of treads and are anti-slipping, durable, and weatherproof.

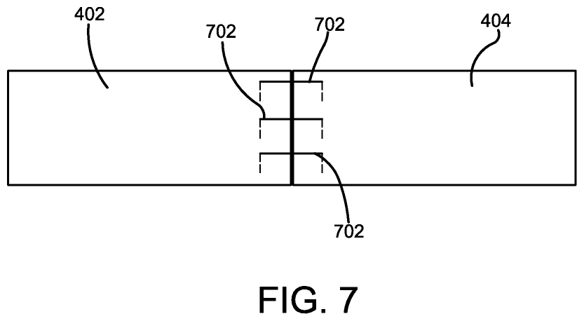

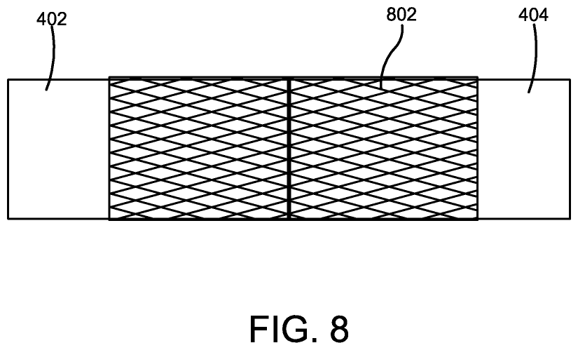

Then, the strips are joined using an adhesive in a preconfigured configuration as described in FIGS. 1 and 2 (Step 608). Alternatively, the strips 402, 404 can be joined using industrial staples 702 (FIG. 7) and/or tubular metal braids 802 (FIG. 8). The joined strips are used for forming one or more structures (i.e., walls, fencing, gates, and other barriers) repurposing the used tires (Step 610). The structures are used for a variety of purposes and are environmentally friendly.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tire repurposing system”, “tire recycling and repurposing system”, “recycling used tire system”, and “system” are interchangeable and refer to the recycling and repurposing used tire system 100 of the present invention.

Notwithstanding the forgoing, the recycling and repurposing used tire system 100 of the present invention can be of any suitable size and configuration as is known in the art without affecting the overall concept of the invention, provided that it accomplishes the above stated objectives. One of ordinary skill in the art will appreciate that the recycling and repurposing used tire system 100 as shown in the FIGS. are for illustrative purposes only, and that many other sizes and shapes of the recycling and repurposing used tire system 100 are well within the scope of the present disclosure. Although the dimensions of the recycling and repurposing used tire system 100 are important design parameters for user convenience, the recycling and repurposing used tire system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rubber tire repurposing system comprising:
a tire feeder module;
a tire separator module; and
a strip formation module;
wherein said tire feeder module having a conveyor belt for receiving used tires into said rubber tire repurposing system;
wherein said tire separator module having an agitator for separating different types of said used tires and for separating tire treads from said used tires;
wherein said strip formation module having a plurality of elongated cutters for cutting individual said tire treads into strips; and
further wherein said tire separator module connected to said tire feeder module.

2. The rubber tire repurposing system of claim 1, wherein said tire feeder module receiving used tires of different sizes.

3. The rubber tire repurposing system of claim 2, wherein said tire feeder module having a water inlet for spraying said used tires.

4. The rubber tire repurposing system of claim 3, wherein said plurality of elongated cutters for uniformly cutting the individual said tire treads into the strips.

5. The rubber tire repurposing system of claim 4 further comprising a tire tube removal module for transferring tire tubes from said strip formation module to said tire tube removal module.

6. The rubber tire repurposing system of claim 5, wherein said water inlet having a cleaning solution for spraying said used tires.

7. The rubber tire repurposing system of claim 6, wherein said agitator having an integrated motor to vibrate and rotate said used tires to separate the different types of said used tires.

8. The rubber tire repurposing system of claim 1 further comprising a strip binder module for capturing and binding two or more said tire tread strips together.

9. The rubber tire repurposing system of claim 8, wherein said binding including a rubber adhesive.

10. The rubber tire repurposing system of claim 8 further comprising a casting module having a plurality of casting structures to form said tire tread strips into a plurality of devices.

11. The rubber tire repurposing system of claim 10, wherein said plurality of devices is selected from a group consisting of a tie-down, an attachment cable, a speed bump, a tire chock, a pet scratching post, and a safety barrier.

12. The rubber tire repurposing system of claim 8, wherein said binding including an adhesive type option for selecting a rubber adhesive from at least two types of rubber adhesive.

13. The rubber tire repurposing system of claim 8 wherein said binding selected from the group consisting of industrial staples and tubular metal braids.

14. A rubber tire repurposing system comprising:
a tire feeder module;
a tire separator module;
a strip formation module; and
a strip binder module;
wherein said tire feeder module having a conveyor belt for receiving used tires into said rubber tire repurposing system;
wherein said tire separator module having an agitator for separating different types of said used tires and for separating tire treads from said used tires;
wherein said strip formation module having a plurality of elongated cutters for cutting individual said tire treads into strips;
wherein said tire separator module connected to said tire feeder module;
wherein said agitator having an integrated motor to vibrate and rotate said used tires to separate the different types of said used tires;
wherein said strip binder module for capturing and binding two or more said tire tread strips together; and
further wherein said binding including a rubber adhesive.

15. The rubber tire repurposing system of claim 14, wherein said tire feeder module having a water inlet for spraying said used tires.

16. The rubber tire repurposing system of claim 15, wherein the plurality of elongated cutters for uniformly cutting the individual said tire treads into the strips.

17. The rubber tire repurposing system of claim 16 further comprising a tire tube removal module for transferring tire tubes from said strip formation module to said tire tube removal module.

18. A method of repurposing rubber tires, the method comprising the steps of:
feeding used tires through a tire feeder module;
separating treads from said used tires through a tire separator module;
cutting strips from said treads through a strip formation module;
joining said strips using an adhesive through a strip binder module;
forming structures of said strips through a casting module;
wherein said tire feeder module having a conveyor belt for receiving said used tires;
wherein said tire separator module having an agitator for separating different types of said used tires and for separating said treads from said used tires;
wherein said strip formation module having a plurality of elongated cutters for cutting individual said treads into said strips;
wherein said tire separator module connected to said tire feeder module;
wherein said agitator having an integrated motor to vibrate and rotate said used tires to separate the different types of said used tires;
wherein said strip binder module for capturing and binding two or more said strips together; and
further wherein said binding including a rubber adhesive.

19. The method of repurposing rubber tires of claim 18, wherein said casting module having a plurality of casting structures to repurpose said strips into a plurality of devices.

20. The method of repurposing rubber tires of claim 19, wherein said plurality of devices is selected from a group consisting of a tie-down, an attachment cable, a speed bump, a tire chock, a pet scratching post, and a safety barrier.
